(19) United States
(12) Patent Application Publication
(10) Pub. No.: US 2022/0019857 A1
(43) Pub. Date: Jan. 20, 2022

(54) OPTIMIZATION DEVICE, METHOD, AND PROGRAM

(71) Applicant: NIPPON TELEGRAPH AND TELEPHONE CORPORATION, Tokyo (JP)

(72) Inventors: Hidetaka ITO, Tokyo (JP); Tatsushi MATSUBAYASHI, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/428,611

(22) PCT Filed: Jan. 23, 2020
(86) PCT No.: PCT/JP2020/002298

§ 371 Date: Aug. 4, 2021

(30) Foreign Application Priority Data
Feb. 6, 2019 (JP) 2019-019368

(51) Int. Cl. G06K 9/62; G06N 7/00

(52) U.S. Cl. CPC G06K 9/6262; G06N 7/005; G06K 9/6228; G06K 9/6215

(57) ABSTRACT

In order to perform optimization of parameters at high speed, an evaluating unit (120) repetitively calculates an evaluated value of machine learning or a simulation while changing a value of a parameter, an optimizing unit (100) uses a model constructed by learning a pair of a value of a parameter of which an evaluated value had been previously calculated and the evaluated value to predict an evaluated value with respect to a value of at least one parameter included in a parameter space specified based on a value of a parameter of which an evaluated value had been last calculated and select a value of a parameter of which an evaluated value is to be calculated next by the evaluating unit (120) based on predicted data of a currently predicted evaluated value and predicted data of a previously predicted evaluated value, and an output unit (180) outputs an optimal value of a parameter based on an evaluated value calculated by the evaluating unit 120.

### TECHNICAL FIELD

The disclosed technique relates to an optimization apparatus, an optimization method, and an optimization program and, particularly, to an optimization apparatus, an optimization method, and an optimization program for optimizing parameters of machine learning and simulations.

### BACKGROUND ART

In machine learning, there are parameters that require manual adjustment. Parameters determine performance of machine learning and adjustment of parameters is imperative. In addition, models for simulating phenomena such as a human behavior model and a car following model also have parameters which require manual adjustment and which affect reproducibility of the models. Since such adjustment is a burden on a user, there are demands for automating adjustment. In consideration thereof, a technique has been proposed for optimally adjusting parameters in an efficient manner by automatically performing trial and error (refer to NPL 1). In optimization, some kind of an evaluated value is prepared and a parameter is adjusted so as to maximize or minimize the evaluated value.

### CITATION LIST

### Non Patent Literature

[NPL 1] Shahriari, B., Swersky, K., Wang, Z., Adams, R. P. and Freitas, de N., “Taking the Human Out of the Loop: A Review of Bayesian Optimization”, Proceedings of the IEEE, Vol. 104, No. 1, pp. 148-175 (2016).

### SUMMARY OF THE INVENTION

### Technical Problem

Optimization by trial and error splits into two processes, namely, selection of a parameter to be evaluated next and evaluation of the selected parameter. In trial and error, optimization is performed while alternately iterating these two processes.

In conventional art, since all parameters are searched all over again in order to select a parameter to be evaluated next for each iteration of trial and error, the process of selecting the parameter to be evaluated next ends up consuming time and prevents parameter optimization from being performed at high speed.

The disclosed technique has been devised in consideration of the circumstances described above and an object thereof is to provide an optimization apparatus, an optimization method, and an optimization program that enables optimization of parameters to be performed at high speed.

### Means for Solving the Problem

In order to achieve the object described above, an optimization apparatus according to the disclosed technique can be configured to include: an evaluating unit which repetitively calculates an evaluated value of machine learning or a simulation while changing a value of the parameter; an optimizing unit which, using a model constructed by learning a pair of a value of a parameter of which an evaluated value had been previously calculated and the evaluated value, predicts an evaluated value with respect to a value of at least one parameter included in a parameter space specified based on a value of a parameter of which an evaluated value had been last calculated and which selects a value of a parameter of which an evaluated value is to be calculated next by the evaluating unit based on predicted data of a currently predicted evaluated value and predicted data of a previously predicted evaluated value; and an output unit which outputs an optimal value of a parameter based on an evaluated value calculated by the evaluating unit.

With the optimization apparatus according to the disclosed technique, an evaluating unit repetitively calculates an evaluated value of machine learning or a simulation while changing a value of a parameter. In addition, an optimizing unit uses a model constructed by learning a pair of a value of a parameter of which an evaluated value had been previously calculated and the evaluated value to predict an evaluated value with respect to a value of at least one parameter included in a parameter space specified based on a value of a parameter of which an evaluated value had been last calculated and selects a value of a parameter of which an evaluated value is to be calculated next by the evaluating unit based on predicted data of a currently predicted evaluated value and predicted data of a previously predicted evaluated value. Furthermore, an output unit outputs an optimal value of a parameter based on an evaluated value calculated by the evaluating unit.

In this manner, when selecting a parameter of which an evaluated value is to be calculated next, by predicting only an evaluated value with respect to a value of a part of parameters and using previous predicted data with respect to other parameters, selection of a parameter to be evaluated next can be accelerated and optimization of parameters can be performed at high speed.

In addition, the optimizing unit can adopt, as the parameter space, a parameter space including a parameter satisfying a condition indicating a readiness to have a correlative relationship with the parameter of which an evaluated value had been last calculated. Furthermore, the optimizing unit can adopt, as the condition indicating a readiness to have a correlative relationship with the parameter of which an evaluated value had been last calculated, a condition requiring that a distance to the parameter of which an evaluated value had been last calculated be within a predetermined distance or a condition requiring that a distance to the parameter of which an evaluated value had been last calculated be shorter than a distance to any of parameters of which an evaluated value had been previously calculated or a constant multiple of the distance.

It is expected that a parameter having a correlative relationship with the parameter of which an evaluated value had been last calculated is to be affected by the parameter of which an evaluated value had been calculated and that a predicted value of the evaluated value is to change significantly. As described above, by specifying a parameter space including a parameter of which a predicted value of an evaluated value is predicted to change significantly, in iterative processing, predicted data of a previously predicted evaluated value can be used and selection of a parameter to be evaluated next can be accelerated.

In addition, the optimizing unit can use, among pairs of a value of a parameter of which an evaluated value had been previously calculated and the evaluated value, a pair of a parameter of which a distance to the parameter of which an evaluated value had been last predicted is within a predetermined distance or a predetermined number of parameters in an ascending order of distances to the parameter of which an evaluated value had been last predicted and an evaluated value of the parameter to learn the model. In this manner, by using a pair of a part of parameters and an evaluated value in consideration of a set of parameters of which predicted data needs to be updated instead of using pairs of all parameters having been previously evaluated and evaluated values thereof to learn a model, learning of the model can be accelerated.

Furthermore, the optimizing unit can use a Gaussian process as the model.

In addition, the optimizing unit can be configured to include: a parameter/evaluated value accumulating unit in which pairs of a value of a parameter of which an evaluated value had been previously calculated and the evaluated value are accumulated; a model applying unit which constructs the model by learning the pairs of a value of a parameter and the evaluated value having been accumulated in the parameter/evaluated value accumulating unit; a predicted data accumulating unit in which predicted data of evaluated values with respect to parameters of which an evaluated value had been previously predicted are accumulated; a predicted data updating unit which uses the model to predict an evaluated value with respect to a value of at least one parameter included in a parameter space that is specified based on a value of the parameter of which an evaluated value had been last calculated and updates predicted data having been accumulated in the predicted data accumulating unit; and an evaluation parameter selecting unit which calculates a degree at which an evaluation needs to be performed next with respect to a value of each parameter based on predicted data accumulated in the predicted data updating unit and which selects a value of a parameter of which an evaluated value is to be calculated next based on the degree.

The predicted data updating unit avoids processing for newly predicting an evaluated value by using predicted data having been predicted in previous iterative processing with respect to a part of parameters. When it is expected that there is no significant change between predicted data in a previous trial and error and predicted data that is supposed to be obtained when constructing a model using a current trial and error, accuracy of prediction hardly changes even when using the predicted data in a previous trial and error. On the other hand, with respect to a predicted data for which a difference is expected between predicted data in a previous trial and error and predicted data to be predicted by a model constructed based on a currently obtained pair of a parameter and an evaluated value, using the previous predicted data causes accuracy of prediction to decline. Therefore, with respect to a range of parameters corresponding to the latter case, a prediction is performed once again based on a new model and predicted data is updated. It should be noted that predicted data to be predicted by the predicted data updating unit can include, in addition to a predicted value of an evaluated value, a plurality of indices related to prediction such as a degree of confidence of prediction.

In addition, an optimization method object according to the disclosed technique is an optimization method in an optimization apparatus including an evaluating unit, an optimizing unit, and an output unit, the optimization method including the steps of: the evaluating unit repetitively calculating an evaluated value of machine learning or a simulation while changing a value of the parameter; the optimizing unit using a model constructed by learning a pair of a value of a parameter of which an evaluated value had been previously calculated and the evaluated value to predict an evaluated value with respect to a value of at least one parameter included in a parameter space specified based on a value of a parameter of which an evaluated value had been last calculated and select a value of a parameter of which an evaluated value is to be calculated next by the evaluating unit based on predicted data of a currently predicted evaluated value and predicted data of a previously predicted evaluated value; and the output unit outputting an optimal value of a parameter based on an evaluated value calculated by the evaluating unit.

Furthermore, an optimization program according to the disclosed technique is a program for causing a computer to function as each unit constituting the optimization apparatus described above.

### Effects of the Invention

As described above, with the optimization apparatus, the optimization method, and the optimization program according to the disclosed technique, when selecting a parameter of which an evaluated value is to be calculated next, by predicting only an evaluated value with respect to a value of a part of parameters and using previous predicted data with respect to other parameters, selection of a parameter to be evaluated next can be accelerated and optimization of parameters can be performed at high speed.

### BRIEF DESCRIPTION OF DRAWINGS

FIG. 1 is a block diagram of an optimization apparatus according to the present embodiment.

FIG. 2 is a diagram showing an example of parameters and evaluated values that are accumulated in a parameter/evaluated value accumulating unit.

FIG. 3 is a diagram showing an example of predicted data that is accumulated in a predicted data accumulating unit.

FIG. 4 is a flow chart showing an example of a flow of optimization processing.

FIG. 5 is a diagram for explaining a parameter space for predicting evaluated values.

### DESCRIPTION OF EMBODIMENT

Hereinafter, an example of a mode for carrying out the disclosed technique will be described in detail with reference to the drawings.

<Acceleration of Parameter Selection>

As described earlier, optimization by trial and error splits into two processes, namely, selection of a parameter to be evaluated next and evaluation of the selected parameter. In the present embodiment, selection of a parameter is accelerated in order to perform optimization of parameters at high speed.

There are at least two conceivable situations that require acceleration of selection of a parameter. The first situation that requires acceleration of selection of a parameter is when the time required to evaluate a parameter is short. When evaluation of a parameter requires a significantly shorter time than selection of a parameter, a total time required by optimization can be considered equivalent to the time required by parameter selection. Therefore, in order to accelerate optimization of a parameter, the selection of a parameter must be accelerated. Examples in which such a situation may occur include using a light-weight simulation to evaluate a parameter in parameter optimization of a simulation model and accelerating learning by parallel processing in parameter optimization of machine learning.

The second situation that requires acceleration of selection of a parameter is when the number of trial and errors is large. Generally, the larger the number of trial and errors, the longer the time required by a single selection of a parameter. This is because, since a determination is made based on previously evaluated results when selecting a parameter, results of evaluations in previous iterations which must be taken into consideration accumulate as the number of trial and errors increases. Therefore, when the number of trial and errors is large, time required by parameter selection may end up being a temporal bottleneck when performing optimization. Examples in which such a situation may occur include an example with a large number of parameters to be adjusted. It is known that when there are a large number of parameters to be adjusted, the number of trial and errors necessary for performing optimization increases. Accordingly, the example above has been derived.

<Configuration of Optimization Apparatus>

The optimization apparatus according to the present embodiment is configured as a computer including a CPU (Central Processing Unit), a RAM (Random Access Memory), a ROM (Read Only Memory), an HDD (Hard Disk Drive), and the like. The ROM stores an optimization program according to the present embodiment. Alternatively, the optimization program may be stored in the HDD.

Still alternatively, for example, the optimization program may be installed in the optimization apparatus in advance. The optimization program may be realized by being stored in a non-volatile storage medium or distributed via a network and appropriately installed in the optimization apparatus. Examples of a non-volatile storage medium include a CD-ROM (Compact Disc Read Only Memory), a magneto-optical disk, a DVD-ROM (Digital Versatile Disc Read Only Memory), a flash memory, a memory card, and the like.

By reading the optimization program stored in the ROM and executing the optimization program, the CPU functions as respective functional units of the optimization apparatus to be described later.

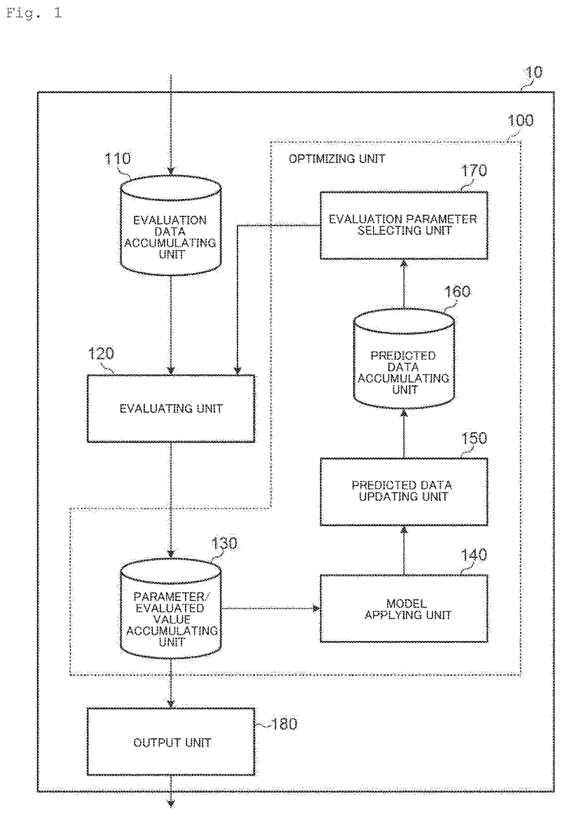

FIG. 1 shows a block diagram of an optimization apparatus 10 according to the present embodiment. As shown in FIG. 1, the optimization apparatus 10 is functionally configured to include an optimizing unit 100, an evaluation data accumulating unit 110, an evaluating unit 120, and an output unit 180. In addition, the optimizing unit 100 is configured to further include a parameter/evaluated value accumulating unit 130, a model applying unit 140, a predicted data updating unit 150, a predicted data accumulating unit 160, and an evaluation parameter selecting unit 170.

Optimization of parameters is performed by iterating a selection of a parameter by the optimizing unit 100 and an evaluation of the parameter by the evaluating unit 120. This is referred to as trial and error, and a set of a selection of a parameter by the optimizing unit 100 and an evaluation of the parameter by the evaluating unit 120 will be referred to as one trial and error. The number of times trial and error is performed signifies the number of times for the set described above.

Hereinafter, as an example of implementation, a case will be described in which the optimization apparatus 10 according to the present embodiment is applied to optimization of a parameter in a simulation of a state of movement of a pedestrian in accordance with a guidance method (hereinafter, referred to as a “pedestrian simulation”). In this example, the evaluation corresponds to performing the pedestrian simulation and the parameter corresponds to a parameter xₜ for determining the guidance method, where t denotes an order in which an evaluation is performed or, in other words, the number of the simulation in a sequence.

Data (hereinafter, referred to as “evaluation data”) necessary for performing the pedestrian simulation is accumulated in the evaluation data accumulating unit 110. Examples of evaluation data include a road configuration, a rate of travel of pedestrians, the number of pedestrians, duration of entry by each pedestrian in a simulation section, routes taken by the pedestrians, and a start time and an end time of a simulation.

The evaluating unit 120 acquires evaluation data accumulated in the evaluation data accumulating unit 110 and, at the same time, receives a parameter t+1 (details will be provided later) from the evaluation parameter selecting unit 170. Using the evaluation data and a parameter xₜ₊₁, the evaluating unit 120 performs a pedestrian simulation and calculates an evaluated value yₜ₊₁. In addition, the evaluating unit 120 outputs the parameter xₜ₊₁ and the evaluated value yₜ₊₁. An example of the evaluated value is the time required by a pedestrian to reach a destination.

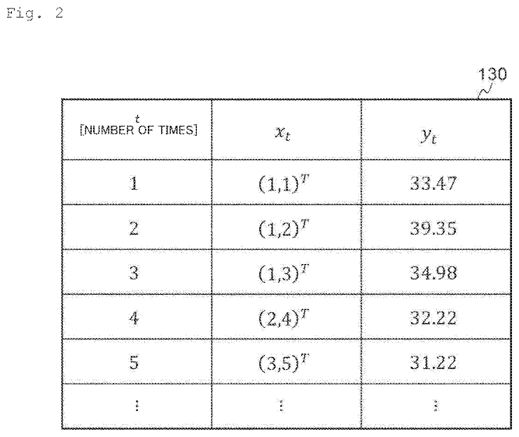

Parameters and evaluated values output when the pedestrian simulation had been previously performed by the evaluating unit 120 are accumulated in the parameter/evaluated value accumulating unit 130. Specifically, a parameter xₜ selected in a t-th (where t=1, 2, . . . ) iteration and a t-th evaluated value yₜ are accumulated in the parameter/evaluated value accumulating unit 130 in association with the number of iterations t. A set of xₜ where t=1, 2, . . . will be denoted by X and a set of yₜ where t=1, 2, . . . will be denoted by Y. FIG. 2 shows an example of parts of parameters and evaluated values that are accumulated in the parameter/evaluated value accumulating unit 130. In accordance with a request, the parameter/evaluated value accumulating unit 130 reads an accumulated parameter and an evaluated value and transmits the parameter and the evaluated value to a functional unit of a request source.

The model applying unit 140 constructs a model for predicting an evaluated value with respect to a parameter from X and Y or a part of X and Y acquired from the parameter/evaluated value accumulating unit 130 and transmits the constructed model to the predicted data updating unit 150.

Using the model transmitted from the model applying unit 140, the predicted data updating unit 150 predicts an evaluated value with respect to some parameters, obtains a predicted value of an evaluated value and values associated with the predicted value, adopts the predicted value and the associated values as predicted data, and transmits the predicted data together with the number of iterations t to the predicted data accumulating unit 160.

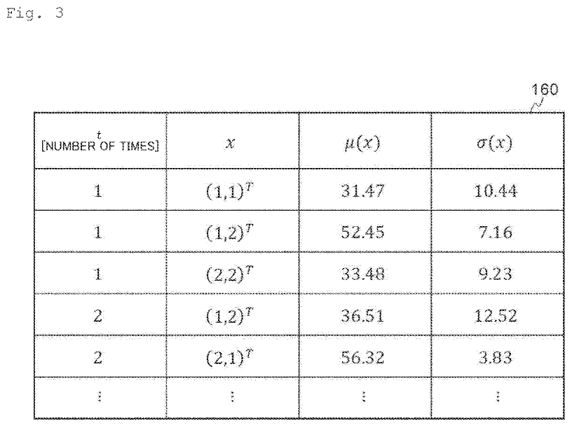

The predicted data accumulating unit 160 accumulates the predicted data received from the predicted data updating unit 150. FIG. 3 shows an example of a part of predicted data that is accumulated in the predicted data accumulating unit 160. In the example shown in FIG. 3, while details will be provided later, an average μ(x) of predicted values of evaluated values and a standard deviation σ(x) of the predicted values when a model based on the Gaussian process is constructed are accumulated in association with the number of iterations t and a parameter x.

When predicted data of a parameter x that is the same as or close to the parameter x of the predicted data received from the predicted data updating unit 150 is accumulated among the accumulated predicted data, the predicted data accumulating unit 160 may update predicted data obtained when the number of iterations t is small with predicted data obtained when t is large. The predicted data accumulating unit 160 transmits the accumulated predicted data to the evaluation parameter selecting unit 170.

Based on the predicted data received from the predicted data accumulating unit 160, the evaluation parameter selecting unit 170 selects one or more parameters to be evaluated next and transmits the selected parameter to the evaluating unit 120.

The output unit 180 outputs an optimal parameter. The optimal parameter can be, for example, a parameter with a highest evaluated value among the parameters accumulated in the parameter/evaluated value accumulating unit 130. An example of an output destination of the parameter is a guidance apparatus for pedestrians.

<Operation of Optimization Apparatus>

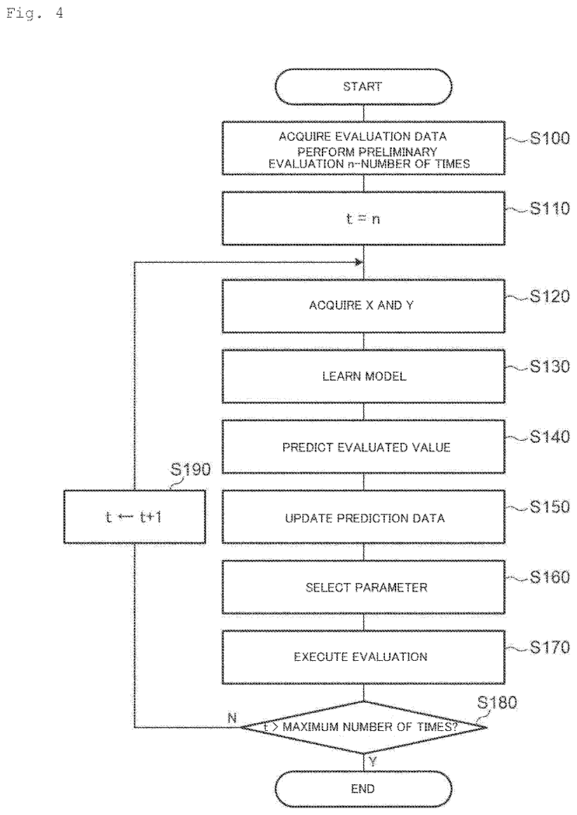

Next, an operation of the optimization apparatus 10 according to the present embodiment will be described with reference to FIG. 4. When an instruction to execute optimization of a parameter is issued in a state where evaluation data fetched from the outside in advance is accumulated in the evaluation data accumulating unit 110, optimization processing shown in FIG. 4 is executed. FIG. 4 is a flow chart showing an example of a flow of optimization processing that is executed by the optimization program according to the present embodiment.

In step S100, the evaluating unit 120 acquires evaluation data from the evaluation data accumulating unit 110. In addition, the evaluating unit 120 performs, n-number of times, a preliminary evaluation for generating data for learning a model to be described later. A value of n is arbitrary. In addition, a method of setting a parameter for which the preliminary evaluation is performed is arbitrary. For example, there are a method of selecting a parameter by random sampling and a method of manually selecting a parameter.

Next, in step S110, the evaluating unit 120 sets the number of iterations t to n.

Next, in step S120, the model applying unit 140 acquires sets X and Y of parameters and evaluated values in previous iterative evaluations from the parameter/evaluated value accumulating unit 130.

Next, in step S130, the model applying unit 140 constructs a model for predicting an evaluated value with respect to a parameter from X and Y or a part of X and Y having been acquired from the parameter/evaluated value accumulating unit 130. An example of the model is the Gaussian process. Using Gaussian process regression enables an unknown index y to be inferred as a probability distribution in the form of a normal distribution with respect to an arbitrary input x. In other words, an average β(x) of predicted values of evaluated values and a standard deviation σ(x) of the predicted values can be obtained. The standard deviation σ(x) of the predicted values represents confidence with respect to the predicted values. The Gaussian process uses a function called a kernel that represents a relationship among a plurality of points. While any kind of kernel may be used in the present embodiment, a Gaussian kernel expressed by Expression (1) below can be used.

[Math. 1]

k(x₁,x₂)=e^{-|x}^{₁}^{-x}^{₂}^{|}^{²}^{/θ} (I)

In this case, θ is a hyperparameter that takes a real number larger than 0. As an example of θ, a value of which a point estimate is a value that maximizes a marginal likelihood of the Gaussian process is used.

When applying the model, the model need not necessarily be learned using all of the pieces of data X and Y. Data used when learning the model is arbitrary. For example, only parameters of which a Euclidean distance with respect to a parameter xₜ having been evaluated when t=n is equal to or less than a given value can be used to learn the model. Alternatively, only one or more parameters in an ascending order of Euclidean distances from the parameter xₜ may be used to learn the model. The model applying unit 140 transmits the learned Gaussian process model to the predicted data updating unit 150.

In step S140, the predicted data updating unit 150 predicts an evaluated value with respect to some parameters x using the model received from the model applying unit 140. The parameters of which an evaluated value is to be predicted are selected in plurality from a parameter space. The parameter space in this case refers to a range in which parameters of which an evaluated value is to be predicted using the model are to be selected.

A method of setting the parameter space is arbitrary. In this case, as an example of the parameter space, a space is selected which includes a point where a predicted value of an evaluated value by the model is supposed to have changed significantly as a result of evaluating the parameter xₜ in a last iteration. Predicted data with respect to the parameter xₜ affects a predicted value of an evaluated value with respect to a parameter with readiness to have a correlative relationship with the parameter xₜ.

For example, when using the Gaussian process and using a representative kernel such as the Gaussian kernel described earlier, a parameter with a close Euclidean distance to xₙ has readiness to have a correlative relationship with xₜ, and the existence of predicted data with respect to xₜ (an evaluated value with respect to xₜ) significantly affects a predicted value of an evaluated value by the model. Therefore, it is conceivably desirable to select a space that includes a parameter close to xₜ.

Examples of a parameter space having such a characteristic include a parameter space satisfying a condition requiring that Euclidean distances from xₜ be equal to or shorter than a certain distance and a parameter space satisfying a condition requiring that Euclidean distances from xₜ be shorter than a Euclidean distance from any of x₁, . . . , xₜ₋₁ or a constant multiple thereof.

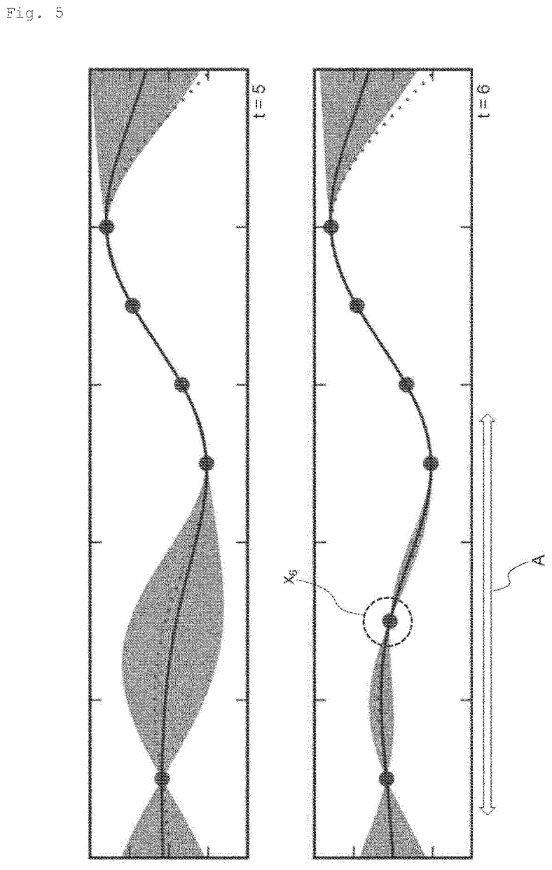

FIG. 5 shows an example of a parameter space with respect to an example of a function. In FIG. 5, a solid line represents a curve indicating a predicted value of an evaluated value, a dotted line represents an objective function, a hatched portion represents confidence of an evaluated value, and a circle represents a selected parameter. As shown in FIG. 5, compared to when t=5, a range (A in FIG. 5) in which a fluctuation in a predicted value due to the model is supposed to be large is conceivably a range in which a parameter x₆ selected in a last iteration has a significant effect on a predicted value.

A selection method of a parameter of which an evaluated value is to be predicted in the parameter space is also arbitrary. For example, there are a method of randomly selecting a parameter and a method of dividing the parameter space into grids (squares) and sequentially selecting the grids (squares).

In addition, the predicted data updating unit 150 transmits, to the predicted data accumulating unit 160, predicted data constituted by the current number of iterations t, a parameter x of which an evaluation has been predicted, and a combination of an average μ(x) of predicted values of evaluated values and a standard deviation σ(x) of the predicted values.

Next, in step 3150, when predicted data of a parameter x that is the same as or close to the parameter x of the predicted data received from the predicted data updating unit 150 in step S140 described above is accumulated among the accumulated predicted data, the predicted data accumulating unit 160 may update predicted data obtained when the number of iterations t is small with predicted data obtained when t is large. A criterion for determining whether or not a value of a parameter is close is arbitrary. It is also possible not to perform an update itself. In addition, when an update is performed, the predicted data accumulating unit 160 transmits the predicted data after the update to the evaluation parameter selecting unit 170.

In step S160, with respect to predicted data (a parameter and a predicted value of an evaluated value with respect to the parameter) transmitted from the predicted data accumulating unit 160, the evaluation parameter selecting unit 170 calculates a function representing a degree at which the parameter needs to be actually evaluated. This function will be referred to as an acquisition function α(x). As an example of the acquisition function, an upper confidence bound shown in Expression (2) below can be used. In this case, μ(x) and σ(x) are, respectively, an average and a standard deviation having been predicted in the Gaussian process. In addition, β(t) is a parameter which, as an example, is set such that β(t)=log(t).

[Math. 2]

α(x)=μ(x)+\sqrt{β(t)}σ(x) (2)

In addition, the evaluation parameter selecting unit 170 selects one or more parameters of which an acquisition function satisfies a condition and transmits the selected parameter to the evaluating unit 120 as a parameter to be evaluated next. An example of the condition is a parameter which maximizes the acquisition function. In other words, a parameter expressed by Expression (3) below is selected as the parameter to be evaluated next.

### [Math. 3]

$$\begin{matrix}[ Math . 3 ] & \\ {x}_{t + 1} = arg {max}_{x ∈ {D}_{predict , t}} α ( x ) & ( 3 )\end{matrix}$$

In this case, D_{predict,t} represents a data set of all parameters x accumulated in the predicted data accumulating unit 160.

Next, in step S170, the evaluating unit 120 performs an evaluation using the evaluation data acquired from the evaluation data accumulating unit 110 and the parameter xₜ₊₁ transmitted from the evaluation parameter selecting unit 170 and obtains one or more evaluated values yₜ₊₁. In addition, the evaluating unit 120 transmits the parameter xₜ₊₁ and the evaluated value yₜ₊₁ to the parameter/evaluated value accumulating unit 130.

Next, in step S180, the evaluating unit 120 determines whether or not the number of iterations exceeds a specified maximum number of times. An example of the number of iterations is 1000 times. When the number of iterations does not exceed the specified maximum number of times, a transition is made to step S190 to increment t by 1 and a return is made to step S120, but when the number of iterations exceeds the specified maximum number of times, the optimization processing is ended. When ending the optimization processing, the output unit 180 outputs a parameter with a highest evaluated value and ends the processing.

As described above, with the optimization apparatus according to the present embodiment, when selecting a parameter of which an evaluated value is to be calculated next, by predicting only an evaluated value with respect to a value of a part of parameters and using previous predicted data with respect to other parameters, selection of a parameter to be evaluated next can be accelerated.

In addition, by learning a model for predicting an evaluated value using only a part of pairs that take update of predicted data into consideration among pairs of a parameter of which an evaluated value had been previously calculated and an evaluated value thereof, learning of a model is accelerated and a parameter to be evaluated next can be selected at high speed.

As described above, since optimization of parameters can be performed at high speed by accelerating selection of a parameter to be evaluated next, sophisticated optimization which has conventionally been impossible due to time constraints can be performed in a case where selection of a parameter becomes a temporal bottleneck as compared to time required to evaluate a parameter or a case where the number of trial and errors must be increased.

It should be noted that respective configurations and steps of processing of the optimization apparatus described in the embodiment presented above are merely examples and may be modified according to situations without deviating from the gist of the disclosed technique.

In addition, the flow of processing of the program described in the embodiment presented above is merely an example and unnecessary steps may be deleted, new steps may be added, or a processing order may be rearranged without deviating from the gist of the disclosed technique.

Furthermore, while a case has been described in the embodiment presented above in which processing according to the embodiment is realized by a software configuration using a computer by executing a program, the embodiment is not limited thereto. For example, the embodiment may be realized by a hardware configuration or a combination of a software configuration and a hardware configuration.

### REFERENCE SIGNS LIST

10 Optimization apparatus
100 Optimizing unit
110 Evaluation data accumulating unit
120 Evaluating unit
130 Parameter/evaluated value accumulating unit
140 Model applying unit
150 Predicted data updating unit
160 Predicted data accumulating unit
170 Evaluation parameter selecting unit
180 Output unit

1. An optimization apparatus, comprising:
an evaluator configured to repetitively evaluate an evaluated value of a parameter of machine learning or a simulation while changing a value of the parameter;
an optimizer configured to, using a model constructed by learning a pair of a value of a parameter of which an evaluated value had been previously determined and the evaluated value, predict an evaluated value with respect to a value of at least one parameter included in a parameter space specified based on a value of a parameter of which an evaluated value had been last determined and which selects a value of a parameter of which an evaluated value is to be determined next by the evaluator based on predicted data of a currently predicted evaluated value and predicted data of a previously predicted evaluated value; and
an output provider configured to output an optimal value of a parameter based on the evaluated value determined by the evaluator.

2. The optimization apparatus according to claim 1, wherein the optimizer adopts, as the parameter space, a parameter space including a parameter satisfying a condition indicating a readiness to have a correlative relationship with the parameter of which an evaluated value had been last determined.

3. The optimization apparatus according to claim 2, wherein the optimizer adopts, as the condition indicating a readiness to have a correlative relationship with the parameter of which an evaluated value had been last determined, a condition requiring that a distance to the parameter of which an evaluated value had been last determined be within a predetermined distance or a condition requiring that a distance to the parameter of which an evaluated value had been last determined be shorter than a distance to any of parameters of which an evaluated value had been previously determined or a constant multiple of the distance.

4. The optimization apparatus according to claim 1, wherein the optimizer uses, among pairs of a value of a parameter of which an evaluated value had been previously determined and the evaluated value, a pair of a parameter of which a distance to the parameter of which an evaluated value had been last predicted is within a predetermined distance or a predetermined number of parameters in an ascending order of distances to the parameter of which an evaluated value had been last predicted and an evaluated value of the parameter to learn the model.

5. The optimization apparatus according to claim 1, wherein the optimizer uses a Gaussian process as the model.

6. The optimization apparatus according to claim 1, wherein the optimizer includes:
a parameter/evaluated value accumulator configured to accumulate pairs of a value of a parameter of which an evaluated value had been previously determined and the evaluated value;
a model applier configured to construct the model by learning the pairs of a value of a parameter and the evaluated value that have been accumulated in the parameter/evaluated value accumulator;
a predicted data accumulator configured to accumulate predicted data of evaluated values with respect to parameters of which an evaluated value had been previously predicted;
a predicted data updater configured to use the model to predict an evaluated value with respect to a value of at least one parameter included in a parameter space that is specified based on a value of the parameter of which an evaluated value had been last determined and updates predicted data having been accumulated in the predicted data accumulator; and
an evaluation parameter selector configured to determine a degree at which an evaluation needs to be performed next with respect to a value of each parameter based on predicted data accumulated in the predicted data updater and to select a value of a parameter of which an evaluated value is to be determined next based on the degree.

7. An optimization method object in an optimization apparatus including an evaluator, an optimizer, and an output provider, the optimization method comprising:
repetitively determining, by the evaluator, an evaluated value of machine learning or a simulation while changing a value of the parameter;
predicting, by the optimizer using a model constructed by learning a pair of a value of a parameter of which an evaluated value had been previously calculated and the evaluated value, an evaluated value with respect to a value of at least one parameter included in a parameter space specified based on a value of a parameter of which an evaluated value had been last determined;
selecting a value of a parameter of which an evaluated value is to be determined next by the evaluator based on predicted data of a currently predicted evaluated value and predicted data of a previously predicted evaluated value; and
outputting, by the output provider, an optimal value of a parameter based on the evaluated value determined by the evaluator.

8. A computer-readable non-transitory recording medium storing a computer-executable optimization program instructions that when executed by a processor cause a computer system to:
repetitively determine, by a evaluator, an evaluated value of machine learning or a simulation while changing a value of the parameter;
predict, by an optimizer using a model constructed by learning a pair of a value of a parameter of which an evaluated value had been previously calculated and the evaluated value, an evaluated value with respect to a value of at least one parameter included in a parameter space specified based on a value of a parameter of which an evaluated value had been last determined;
select a value of a parameter of which an evaluated value is to be determined next by the evaluator based on predicted data of a currently predicted evaluated value and predicted data of a previously predicted evaluated value; and
output, by an output provider, an optimal value of a parameter based on an evaluated value determined by the evaluator.

9. The optimization apparatus according to claim 2, wherein the optimizer uses, among pairs of a value of a parameter of which an evaluated value had been previously determined and the evaluated value, a pair of a parameter of which a distance to the parameter of which an evaluated value had been last predicted is within a predetermined distance or a predetermined number of parameters in an ascending order of distances to the parameter of which an evaluated value had been last predicted and an evaluated value of the parameter to learn the model.

10. The optimization apparatus according to claim 3, wherein the optimizer uses, among pairs of a value of a parameter of which an evaluated value had been previously determined and the evaluated value, a pair of a parameter of which a distance to the parameter of which an evaluated value had been last predicted is within a predetermined distance or a predetermined number of parameters in an ascending order of distances to the parameter of which an evaluated value had been last predicted and an evaluated value of the parameter to learn the model.

11. The optimization apparatus according to claim 2, wherein the optimizer uses a Gaussian process as the model.

12. The optimization apparatus according to claim 3, wherein the optimizer uses a Gaussian process as the model.

13. The optimization apparatus according to claim 4, wherein the optimizer uses a Gaussian process as the model.

14. The optimization apparatus according to claim 2, wherein the optimizer includes:
a parameter/evaluated value accumulator configured to accumulate pairs of a value of a parameter of which an evaluated value had been previously determined and the evaluated value;
a model applier configured to construct the model by learning the pairs of a value of a parameter and the evaluated value that have been accumulated in the parameter/evaluated value accumulator;
a predicted data accumulator configured to accumulate predicted data of evaluated values with respect to parameters of which an evaluated value had been previously predicted;
a predicted data updater configured to use the model to predict an evaluated value with respect to a value of at least one parameter included in a parameter space that is specified based on a value of the parameter of which an evaluated value had been last determined and updates predicted data having been accumulated in the predicted data accumulator; and
an evaluation parameter selector configured to determine a degree at which an evaluation needs to be performed next with respect to a value of each parameter based on predicted data accumulated in the predicted data updater and to select a value of a parameter of which an evaluated value is to be determined next based on the degree.

15. The optimization apparatus according to claim 3, wherein the optimizer includes:
a parameter/evaluated value accumulator configured to accumulate pairs of a value of a parameter of which an evaluated value had been previously determined and the evaluated value;
a model applier configured to construct the model by learning the pairs of a value of a parameter and the evaluated value that have been accumulated in the parameter/evaluated value accumulator;
a predicted data accumulator configured to accumulate predicted data of evaluated values with respect to parameters of which an evaluated value had been previously predicted;
a predicted data updater configured to use the model to predict an evaluated value with respect to a value of at least one parameter included in a parameter space that is specified based on a value of the parameter of which an evaluated value had been last determined and updates predicted data having been accumulated in the predicted data accumulator; and
an evaluation parameter selector configured to determine a degree at which an evaluation needs to be performed next with respect to a value of each parameter based on predicted data accumulated in the predicted data updater and to select a value of a parameter of which an evaluated value is to be determined next based on the degree.

16. The optimization apparatus according to claim 4, wherein the optimizer includes:
a parameter/evaluated value accumulator configured to accumulate pairs of a value of a parameter of which an evaluated value had been previously determined and the evaluated value;
a model applier configured to construct the model by learning the pairs of a value of a parameter and the evaluated value that have been accumulated in the parameter/evaluated value accumulator;
a predicted data accumulator configured to accumulate predicted data of evaluated values with respect to parameters of which an evaluated value had been previously predicted;
a predicted data updater configured to use the model to predict an evaluated value with respect to a value of at least one parameter included in a parameter space that is specified based on a value of the parameter of which an evaluated value had been last determined and updates predicted data having been accumulated in the predicted data accumulator; and
an evaluation parameter selector configured to determine a degree at which an evaluation needs to be performed next with respect to a value of each parameter based on predicted data accumulated in the predicted data updater and to select a value of a parameter of which an evaluated value is to be determined next based on the degree.

17. The optimization apparatus according to claim 5, wherein the optimizer includes:
a parameter/evaluated value accumulator configured to accumulate pairs of a value of a parameter of which an evaluated value had been previously determined and the evaluated value;
a model applier configured to construct the model by learning the pairs of a value of a parameter and the evaluated value that have been accumulated in the parameter/evaluated value accumulator;
a predicted data accumulator configured to accumulate predicted data of evaluated values with respect to parameters of which an evaluated value had been previously predicted;
a predicted data updater configured to use the model to predict an evaluated value with respect to a value of at least one parameter included in a parameter space that is specified based on a value of the parameter of which an evaluated value had been last determined and updates predicted data having been accumulated in the predicted data accumulator; and
an evaluation parameter selector configured to determine a degree at which an evaluation needs to be performed next with respect to a value of each parameter based on predicted data accumulated in the predicted data updater and to select a value of a parameter of which an evaluated value is to be determined next based on the degree.

18. The method according to claim 7, wherein the optimizer adopts, as the parameter space, a parameter space including a parameter satisfying a condition indicating a readiness to have a correlative relationship with the parameter of which an evaluated value had been last determined.

19. The method according to claim 18, wherein the optimizer adopts, as the condition indicating a readiness to have a correlative relationship with the parameter of which an evaluated value had been last determined, a condition requiring that a distance to the parameter of which an evaluated value had been last determined be within a predetermined distance or a condition requiring that a distance to the parameter of which an evaluated value had been last determined be shorter than a distance to any of parameters of which an evaluated value had been previously determined or a constant multiple of the distance.

20. The method according to claim 18, wherein the optimizer uses, among pairs of a value of a parameter of which an evaluated value had been previously determined and the evaluated value, a pair of a parameter of which a distance to the parameter of which an evaluated value had been last predicted is within a predetermined distance or a predetermined number of parameters in an ascending order of distances to the parameter of which an evaluated value had been last predicted and an evaluated value of the parameter to learn the model.
